(19) United States
(12) Patent Application Publication
(10) Pub. No.: US 2024/0406667 A1
(43) Pub. Date: Dec. 5, 2024

(54) APPARATUS AND METHOD FOR TRIGGERING A CENTERING OF A HEAD-TRACKING SYSTEM ON A HEAD-WORN WEARABLE DEVICE

(71) Applicant: HARMAN INTERNATIONAL INDUSTRIES, INCORPORATED, Stamford, CT (US)

(72) Inventor: Alfredo FERNANDEZ FRANCO, Sherman Oaks, CA (US)

(73) Assignee: HARMAN INTERNATIONAL INDUSTRIES, INCORPORATED, Stamford, CT (US)

(21) Appl. No.: 18/699,042

(22) PCT Filed: Oct. 7, 2022
(86) PCT No.: PCT/US2022/046109

§ 371 Date: Apr. 5, 2024

Related U.S. Application Data
(60) Provisional application No. 63/253,792, filed on Oct. 8, 2021.

(51) Int. Cl. H04S 7/00; H04R 1/10; H04R 5/033

(52) U.S. Cl. CPC H04S 7/304; H04R 1/1008; H04R 1/1041; H04R 5/033; H04S 2400/11; H04S 2420/01

(57) ABSTRACT

A headphone assembly including headphones, a switch, at least one motion detector, and at least one processor is provided. The switch is configured to transmit a first signal indicative of a command to establish a relative orientation for the headphones. The at least one motion detector is configured to transmit a second signal indicative of movement of the headphones relative to a user's head. The at least one processor is programmed to receive a first signal to establish the relative orientation of the headphones and to receive the second signal that indicates that the headphones are moving relative to the user's head. The at least one processor is further programmed to determine that the headphones are in a stable state and to establish the relative orientation of the headphones while positioned on the user's head in response to at least determining that the headphones are in the stable state.

### CROSS-REFERENCE TO RELATED APPLICATIONS

This application claims the benefit of U.S. provisional application Ser. No. 63/253,792 filed Oct. 8, 2021, the disclosure of which is hereby incorporated in its entirety by reference herein.

### TECHNICAL FIELD

Aspects disclosed herein generally relate to, among other things, an apparatus and method for triggering a centering of a head tracking system on a head-worn wearable device. The apparatus and method for triggering the centering of the head tracking system may correspond to gaming headphones that track a user's head motion to provide immersive sound quality while interfacing with a gaming device. These aspects and others will be discussed in more detail herein.

### BACKGROUND

A head tracking system may include headphones (or headsets) and are generally worn on a user's head while listening to audio. The head tracking system may track a relative orientation of the user's head and provide electrical outputs indicative of the relative orientation of the user's head. In this regard, the audio played back by the headphones may adjust real or virtual surround sound settings and/or active noise cancellation (ANC) attributes based on the relative orientation of the user's head.

### SUMMARY

In at least one embodiment, a headphone assembly including headphones, a switch, at least one motion detector, and at least one processor is provided. The switch is configured to transmit a first signal indicative of a command to establish a relative orientation for the headphones. The at least one motion detector is configured to transmit a second signal indicative of movement of the headphones relative to a user's head. The at least one processor is programmed to receive a first signal to establish the relative orientation of the headphones and to receive the second signal that indicates that the headphones are moving relative to the user's head. The at least one processor is further programmed to determine that the headphones are in a stable state and to establish the relative orientation of the headphones while positioned on the user's head in response to at least determining that the headphones are in the stable state.

In at least one another embodiment, a computer-program product embodied in a non-transitory computer readable medium that is programmed for determining the relative orientation of headphones is provided. The computer-program product include instructions is executable by at least one processor for receiving a first signal indicative of a command to establish a relative orientation for the headphones from a switch to establish the relative orientation of the headphones and receiving a second signal indicative of movement of the headphones relative to a user's head. The computer-program product include instructions is executable by at least one processor for determining that the headphones are in a stable state after moving relative to the user's head and establishing the relative orientation of the headphones while positioned on the user's head in response to at least determining that the headphones are in the stable state.

In another embodiment, the headphone assembly includes a headphone assembly including headphones, at least one motion detector, and at least one processor. The at least one motion detector configured to transmit a first signal indicative of movement of the headphones. The at least one processor is programmed to determine that the headphones are on a user's head and to establish a relative orientation of the headphones while positioned on the user's head as a frame of reference for subsequent relative orientation measurements in response to at least determining that the headphones are in a stable state while being worn by the user and after the determining that the headphones are on the user's head.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts a head tracking system in accordance with one embodiment;

FIG. 2 depicts a method for centering the head tracking system in accordance with one embodiment;

FIG. 3 depicts another method for centering the head tracking system in accordance with one embodiment; and

FIG. 4 depicts an example of an apparatus exhibiting a relative orientation.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that the controllers as disclosed herein may include various processors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more processors to execute a computer-program that is embodied in a non-transitory computer readable medium that is programmed to perform any number of the functions as disclosed. Further, the controller(s) as provided herein includes a housing and the various number of processors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

Aspects disclosed herein generally provide for a head tracking system that undergoes a recentering method to ensure that a frame of reference (or center point) of a relative orientation of the head tracking system matches an orientation of the user's head. In one example, this may be achieved without requiring any interaction between the user and the head tracking system. The head tracking system may be used in connection with headphones, for example, gaming headphones or headphones that are not used for gaming purposes. Some head tracking systems are known to require the user to trigger the system in some fashion (e.g., select a switch on the gaming headphones) to undergo the recentering event. Such a triggering is manual and causes the user to look away or move the respective position of their head from their normal head position while selecting the switch. The movement or tilting of the head while locating and ultimately selecting the switch on the gaming headphones may cause a mismatch from the head tracking system's frame of reference and what is considered the correct user's frame of reference. The aspects disclosed herein is generally simple and may not require the user to be aware of the head tracking system. In addition, the aspects noted herein ensures that the recentering event has a high probability of changing the head tracker's frame of reference to the natural relative orientation of the user's head.

In at least one embodiment, a headphone assembly is provided. The headphone assembly includes at least one motion detector, and at least one processor. The at least one motion detector is configured to transmit signal indicative of movement of the headphones away from a stable surface, the headphones being in motion and the headphones being worn by the user while the user does not move. The at least one processor is programmed to determine that the headphones are being worn by the user and that the user is in a motionless state based on one of the signals. The at least one motion detector is further configured to establish a relative orientation of the headphones while the headphones are positioned on the user's head and provide a frame of reference of the headphone based on the relative orientation in subsequent relative orientation measurements.

In at least one embodiment, a computer-program product embodied in a non-transitory computer readable medium that is programmed for determining the relative orientation of headphones is provided. The computer-program product includes instructions executable by at least one processor for receiving a first signal indicative of movement of the headphones away from a stable surface (e.g., horizontal surface). The computer-program product includes instructions for determining that the headphones are in a motionless state on the user's head and for establishing a relative orientation of the headphones while positioned on the user's head to establish the relative orientation as a frame of reference for subsequent relative orientation measurements.

In at least one embodiment, a headphone assembly includes a switch, at least one motion detector, and at least one processor. The switch is configured to transmit a first signal indicative of a command to obtain a new frame of reference for measurements of relative orientations of a user's head while headphones are positioned thereon. The at least one motion detector is configured to transmit a second signal indicative of the headphones being worn by the user and the user's head being motionless. The at least one processor is programmed to receive the first signal from the switch to obtain the new frame of reference for the measurements of the relative orientation n of the user's head and to receive the second signal that indicates that the headphones are being worn by the user and the user's head being motionless. The at least one processor is further programmed to determine that the headphones are in a motionless state on the user's head and to establish the relative orientation of the headphones while positioned on the user's head and to utilize the use that orientation as a frame of reference while the headphones are positioned on the user's head in a motionless state.

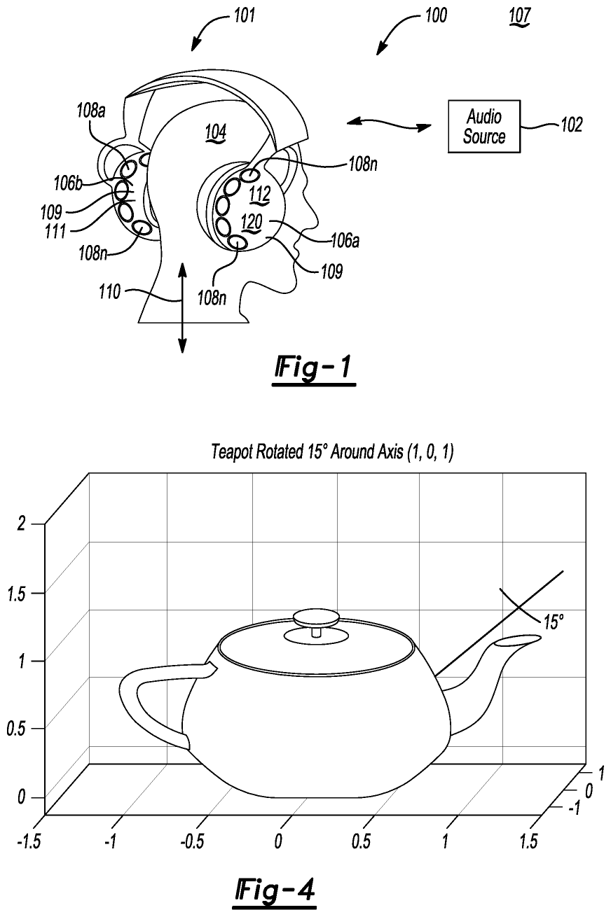

FIG. 1 generally depicts a headphone assembly (or head tracking system) 100 in accordance with one embodiment. The head tracking system 100 includes headphones 101 that transmit audio data from an audio source 102 to a user 104 who hears the headphones 101. In one example, the audio source 102 may be a virtual audio source that includes, among other things, the process of encoding audio in three dimensions, passively or interactively. The playback of the virtual audio may be experienced on stereo, surround, or standard speakers on the headphones 101. The headphones 101 may be wirelessly connected to the audio source 102. In another example, the headphones 101 may be hardwired coupled to the audio source 102. The audio source 102 may be considered as a three-dimensional audio source. In one example, the headphones 101 may be gaming headphones that interface with a gaming system 107 that includes the audio source 102. The headphones 101 may engage in bi-directional wireless communication with the gaming system 107 via Bluetooth or other suitable wireless communication protocol. Various non-limiting examples of a gaming system 107 (or platforms) may include Xbox®, PlayStation®, Nintendo®, etc. It is recognized that the gaming system 107107 may also comprise any laptop, mobile device, or tablet that enables the user 104 to play any game thereon. The audio source 102 may also be the laptop, the mobile device, or the tablet that provides audio therefrom.

The headphones 101 includes a first ear cup 106a and a second ear cup 106b that each include a loudspeaker (not shown) to provide audio from the audio source 102 to the user 104. It is recognized that the headphones 101 may also include a microphone 109 for wireless transmission to the gaming system 107 so that the user's audio may be provided to other gamers/users who are engaged in playing a video game. It is known that the gaming system 107 may provide such audio via an internet protocol for delivery to other users who are actively on the gaming systems at any location that has access to the internet. At least one of the ear cups 106a, 106b may include any number of motion detectors 108a-108n positioned thereon to detect movement of the headphones 101. The microphone 109 may also transmit audio data to the any or more of the mobile device, the laptop, or the tablet for any other purposes that do not involve gaming.

In general, the headphones 101 may track horizontal and vertical movements of the user's head via motion detectors 108a-108n and provide an output indicative of a relative orientation of the user's head to the gaming system 107 or audio system (not shown). The relative orientation may generally be defined as an orientation, angular position, attitude, or direction of an object such as, for example, a line, plane, or rigid body is part of a description of how the line, plane or rigid body is placed in the space it occupies. The relative orientation also refers to an imaginary rotation that is needed to move the object from a reference placement to its current placement. A rotation may not be enough to reach the current placement. It may be necessary to add an imaginary translation. The imaginary translation may be referred to as the object's location (or position, or linear position). The location and orientation define the manner in which the object is placed in space. The above-mentioned imaginary rotation and translation may occur in any order, as the orientation of an object does not change when the object translates, and the object location does not change when the object rotates.

The headphones 101 may also include at least one gyroscope 109 (hereafter “the gyroscope 109”) and at least one accelerometer 111 (hereafter “the accelerometer 111”). The gyroscope 109 is generally configured to measure orientation and an angular velocity of the user's head. The accelerometer 111 is configured to measure a linear acceleration. In one example, the gyroscope 109 and the accelerometer 111 may be combined into a six-degrees-of-freedom inertial measurement unit (IMU).

The headphones 101 may then adjust the playback of the audio being provided by the audio source 102 of the gaming system 107 based on the location of the user's head while wearing the headphones 101. In this regard, the audio that is played back by the gaming headphones may adjust real or virtual surround sound settings and/or active noise cancellation (ANC) attributes based on the location of the user's head. It is recognized that while the headphones 101 are disclosed herein with reference to the gaming system 107, the headphones 101 may be utilized for a number of different applications other than gaming. For example, the headphones 101 as disclosed herein may, for example, relate to any headphone 100 that renders three-dimensional audio and may be used for movies, pro-audio mixing, conference systems, etc.

In general, the system 106 requires the orientation of the head as the user 104 moves his/her head and the orientation of the head as the head changes relative to the position of the 3D audio source being rendered (e.g., the audio source 102). When the orientation of the head changes, the audio source 102 processes a new set of filters in order to render the 3D audio source accurately. This generally entails, for example, that a new set of different head related transfer function (HRTF) needs to be used to filter the audio material provided by the audio source 102. The HRTF generally corresponds to a response that characterizes how an ear receives sound from a point in space. As sound is received by the listener, the size and shape of the head, ears, ear canal, density of the head, size and shape of nasal and oral cavities, transform the sound and affect how the sound is perceived which boosts some frequencies and attenuating others. For example, if a virtual source (or virtual audio source) is located in front of the user and the user rotates his/her head 90 degrees to the right, that virtual source will be the equivalent of a virtual audio source at 90 degrees to the left of the user. The virtual audio source may be louder on the left ear than on the right ear.

As noted above, the relative orientation and/or location of the user's head is generally of interest for any three-dimensional audio rendering system and also in reference to gaming. For example, it is desirable to provide high quality surround sound while the user's head moves while engaged in the game. Surround sound generally provides directional awareness so that the user 104 has knowledge of what is going around him or her based on the game that the user is engaged with. As the user's head may move horizontally and/or vertically, the playback of the audio in a surround sound format needs to take into account the location and the relative orientation of the user's head and adjust the surround sound properties based on the location of the user's head. For example, in the event the user's head is turned to the left, the headphones 101 need to adjust left and right channels of the surround sound to account for the fact that the user's left ear is now positioned in the rear of the user's head and the user's right ear is positioned at a center of the user's head. Similarly, if the user's head is turned to the right, the headphones 101 need to adjust left and right channels of the surround sound to account for the fact that the user's right ear is now positioned in front of the user's head and the user's left ear is positioned rearward of the user's head. In general, a frame of reference (or center point) needs to be established by the headphones 101 to calculate or determine new relative orientation of the user's head on the polar axis. The need to have information corresponding to the relative orientation of the user's head with respect to a virtual three-dimensional audio sound source may enable the headphones 101 to reconstruct or select the correct the HRTF for a given virtual source.

At least one processor 112 (hereafter “the processor 112”) is operably coupled to the motion detectors 108a-108n. The processor 112 is generally configured to detect a relative position of the headphones 101 with respect to a gravity vector (or along an axis 110) based signals received from the motion detectors 108a-108n while performing a re-centering operation. In general, the relative orientation may correspond to an orientation of the object with respect to the gravity vector (along the axis 110) when a measurement is performed. This may be considered the frame of reference of center. The recentered orientation may be considered the current orientation of the headphones 101 minus the relative orientation of the headphones 101.

As noted above, the re-centering operation generally corresponds to the user 104 (i.e., the processor 112) establishing a relative orientation's frame of reference for the headphones 101. The relative orientation, or “center” may be represented in, for example, quaternions and may be represented as [1, 0, 0, 0] (for [w, x, y, z.]), where w corresponds to a rotation around the x, y, z axis. The processor 112 is further configured to determine whether the headphones 101 are positioned on a horizontal surface (e.g., table) based on signals from the motion detectors 108a-108n. Generally, the processor 112 may determine whether the headphones 101 is positioned on a stable (or resting) surface. For example, the processor 112 may monitor outputs from the motion detectors 108a-108n and determine whether the headphones 101 are positioned on a table or worn on the user's head based on at least an absolute orientation of the headphones 101 with respect to the axis 110 (e.g., the gravity vector). The absolute orientation is generally defined as a location that is relative to “world” coordinates. The absolute orientation corresponds to the orientation of an object with respect to its gravity vector and magnetic north. It is recognized that the relative orientation of the headphones 101 may differ or be different than the absolute orientation of the headphones 101 since the headphones 101 when having a relative orientation may not be in a true absolute orientation due to the positioning of the user's head which may differ from person to person. The processor 112 is also configured to detect or determine movement events caused by the user 104 when placing the headphones 101 on the user's head and a relative stability of the headphones 101 once placed on the user's head.

In general, the motion detectors 108a-108n may provide information indicative of the relative orientation of the user's head to the processor 112. The processor 112 may compensate for the data provided by the motion detectors 108a-108n by executing operations related to, for example, a quaternion rotation and/or a translation via, for example, a Euclidian x, y, z translation. In this case, the motion detectors 108a-108n may be positioned on an earcup of the headphones 101 or on a headband of the headphones 101. In one example, a translation may not be required since on a larger number of use cases, the relative orientation and position of the user's head may be of interest as opposed to the absolute position and orientation of the user's head. One example of a headphone system that may require the absolute position and orientation is a volumetric virtual reality (VR) experience where the user can walk around a virtual space.

For example, when the user lifts the headphones 101 from a surface, the motion detectors 108a-108n transmit signals indicative of the headphones 101 being in motion to the processor 112 of the headphones 101 Once the processor 112 detects that the headphones 101 are being worn by the user 104, the processor 112 may monitor signals from the motion detectors 108a-108n to determine if the headphones 101 have been stable (e.g., low level of motion) on the user's head for a predetermined length of time “n”. The low level of motion (or headphone stability) generally corresponds to movement that is caused by the user due to involuntary non-pathological head tremors. In other words, the user is not performing any voluntary movements.

In response to the headphones 101 being stable for the predetermined length of time, the processor 112 may then reorientate the frame of reference (or center point) of the head tracking system 100 to the current relative orientation of the user's head. It is recognized that the center point (or frame of reference) may not be perfectly centered (e.g., quaternions represented as [1, 0, 0, 0]). The center point is used as a frame of reference for subsequent relative orientation measurements. As noted above, the relative orientation may correspond to an orientation of the object with respect to the gravity vector (along the axis 110) when a measurement is performed. Similarly, this may be considered the frame of reference of center. As also noted above, the recentered orientation may be considered the current orientation of the headphones 101 minus the relative orientation of the headphones 101. Thus, in this regard, orientation may be measured as quaternions (i.e., “qₙ”). In quaternions, if the relative orientation used as a frame of reference is “q0” and a new relative orientation measurement is “q1”, then the “recentered” version of q1 is generally defined as: q1−q0

However, in the scenario presented with respect to establishing the center point (or the relative orientation), such a center point may be adequate to provide location readings with respect to the position of the headphones 101 as the user 104 moves his/her head to enable surround sound audio attributes to be adjusted during the gaming event.

In another embodiment, the headphones 101 may include a switch (or button) 120 positioned thereon to trigger the re-centering operation. For example, the button 120 may be positioned on any of the ear cups 106a or 106b. The processor 112 may be operably coupled to the button 120. To perform the re-centering operation, the user 104 may select the button 120. In response to the user 104 selecting the button 120, the processor 112 triggers a timer to wait for the user 104 to return to the natural head's relative orientation. Upon expiration of the timer, the processor 112 waits for the headphones 101 to be stable. While the processor 112 waits for the headphones 101 to be in a stable state, if motion is detected by the processor 112, the processor 112 generates and transmits an audio cue to the user indicating that movement is occurring. The audio cue serves as an indicator to the user to keep his/her head still during the re-centering operation. When the processor 112 detects that the user is still based on signals transmitted from the motion detectors 108a-108n, the microprocess may then store (or save) the relative orientation of the headphones 101 as the frame of reference (or center point) for subsequent relative orientation measurements. The processor 112 may then transmit another audio cue that the recentering procedure is finished.

FIG. 2 depicts a method 200 (or state diagram 200) for centering the head tracking system 100 in accordance with one embodiment.

At state 202, the processor 112 of the headphones 101 determines whether the headphones 101 are on a surface (e.g., any surface that does not include the user's head) and are motionless based on outputs from the motion detectors 108a-108n. In general, “On_Surface_State” generally corresponds to the headphones 101 being motionless and positioned on a flat surface. The “Not_On_Surface_Event generally corresponds to the headphones 101 begin detected as being motionless on a flat surface (or other surface upon which the headphones 101 may lie when not positioned on the user's head). As noted above, the processor 112 may monitor outputs from the motion detectors 108a-108n and determines whether the headphones 101 are positioned on a table or worn on the user's head based on at least the orientation of the headphones 101 with respect to the axis 110 (e.g., the gravity vector). If the processor 112 determines that the headphones 101 are not on the surface, the diagram 200 moves to state 204. If the processor 112 determines that the headphones 101 are still on the flat surface, then the method 200 moves back to operation 202.

In state 204, the method 200 is in a “Wait_for_Tremor_State”. In this state, the processor 112 may be waiting for one or more signals that indicate that the headphones 101 are being worn by the user. Tremors may be defined as small movements caused by involuntary, non-pathological contractions of muscles. For example, the processor 112 waits for the headphones 101 to be placed on the user's head which causes tremors to the headphones 101. In this case, a plurality of small movements may be indicative of the user 104 having placed the headphones 101 on his/her head. For example, the gyroscope 109 and the accelerometer 111 that forms the IMU is configured to provide information that is indicative of whether the headphones 101 are being worn by the user. The motion detectors 108a-108n generally transmit signals indicative of such smaller movements (or small tremors) to the processor 112 to determine this condition. The processor 112 triggers a timer to correspond to a predetermined length of time that the processor 112 waits for the detection of the placement of the headphones 101 in his/her head after the headphones 101 have been moved from the stable surface. If the first timer is still running and the movements are not detected, then the diagram 200 remains in the state 204. When tremors consistent with the headphones 101 being positioned on the user's head are detected (e.g., the processor 112 detects the small tremors), then the diagram 200 moves to state 206. If the timer expires and the processor 112 does not receive the signals indicative of smaller movements (or that the user has not placed the headphones 101 on his/her head), then processor 112 remains in state 204 until the small movements are detected.

In state 206, the processor 112 waits to transition from the tremor state to a stable state based on signals from the motion detectors 108a-108n. The stable state generally corresponds to the headphones 101 no longer exhibiting any movement while positioned on the user's head (i.e., the user's head is also no longer exhibiting any movement). In the event the processor 122 determines that the headphones 101 are moving (e.g., the user's head is still moving), the processor 112 transmits an audio cue to the user to notify the user that his/her head is moving and not still. Upon the processor 122 determining that the headphones 101 are still being worn by the user and that the headphone 101 have come to the stable state, then the diagram moves to state 208.

In state 208, the processor 122 stores or saves the orientation information and location information of the headphones 101 based on signals provided by the motion detectors 108a-108n as the center point (or frame of reference for the headphones 101). As noted above, the motion detectors 108a-108n may report the relative orientation (or center point) of the headphones 101 and thus the user's head relative orientation via quaternions. In this case, the processor 122 designates the relative orientation of the headphones 101 while positioned on the user's head as a frame of reference for subsequent relative orientation measurements. For example, the headphones 101 may compare subsequent relative orientation measurements of the headphones 101 to the designated relative orientation to determine the location of the user's head and to adjust audio playback based on the location of the user's head. After the processor 122 designates or establishes the relative orientation, the headphones 101 may then transmit another audio cue to the user to indicate that the recentering method 200 is complete.

The method 200 generally represents the use case whereby the headphones 101 are located on a flat surface (e.g., On_Surface_State). The user then picks up the headphones 101, triggering a Not_On_Surface_Event. At this point, the system 100 waits for the user to place the headphones 101 on his/her head (e.g., Wait_For_Tremor_State). Once the system 100 detects that the headphones 101 are being worn, an “On_Head_Event” is triggered and the system 100 waits for the user to no longer move his/her head. If the user moves, the system 100 renders a “Recentering Audio Cue” indicating to the user that movement has been detected and this condition prevents recentering. Once the user remains still, the Stability_Event is detected and the system 100 performs the recentering (e.g., Recentered_State)

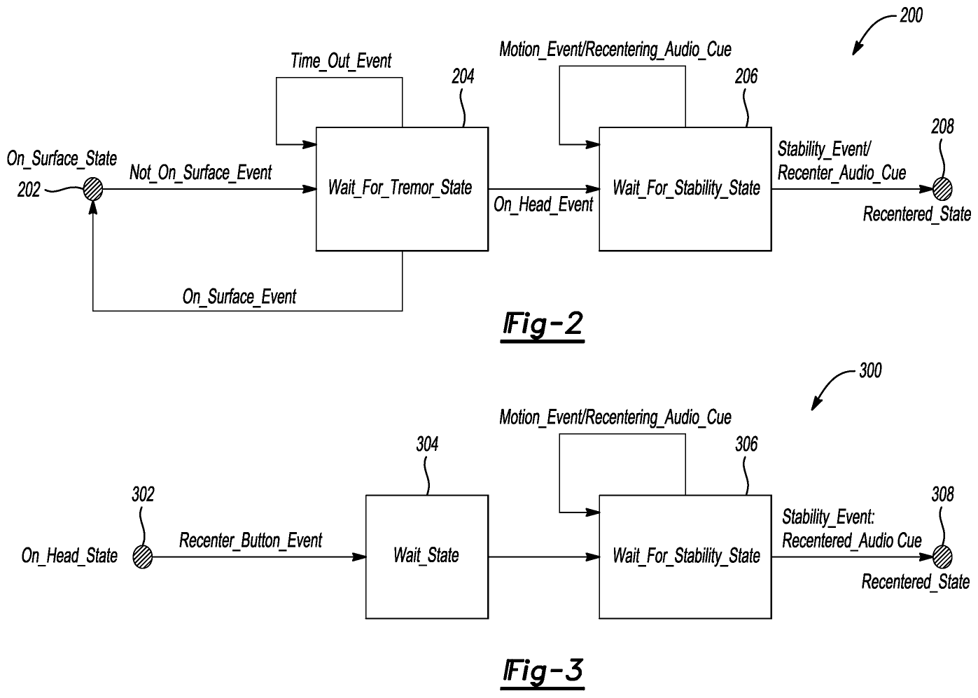

FIG. 3 depicts another method 300 (or state diagram 300) for centering the head tracking system 100 in accordance with one embodiment.

In state 302, the user 104, while wearing the headphones, selects the button 120 on the headphones 101 to initiate the re-centering operation. The “Recenter_Button_Event” corresponds to the user selecting the button 120 on the headphones 101. The diagram 300 then moves to state 304. In state 304, the processor 112 triggers a first timer that runs for a predetermined amount of time (e.g., 3 seconds). The first timer may generally correspond to a delay to enable the user to reach a natural head orientation. It is recognized that in this state and while referencing the natural head orientation, this may not necessarily entail that the user positions his/her head in a perfectly centered spot, but simply that the user places his/her head in a location that is where the user would normally position his/her head.

In state 306, the processor 112 monitors signals from the motion detectors 108a-108n to determine when the headphones 101 reach the stable state. For example, the processor 112 triggers a second timer that runs for a predetermined amount of time to wait for the headphones 101 to reach a stable state (e.g., the user's head is motionless). Upon a determination that the headphones 101 have reached the stable state within the predetermined amount of time, the processor 112 then saves or stores the current relative orientation of the headphones 101 as the new frame of reference. In this case, the processor 122 designates the relative orientation (or center position) of the headphones 101 while positioned on the user's head as a frame of reference for subsequent relative orientation measurements. For example, the headphones 101 may compare subsequent relative orientation measurements of the headphones 101 to the designated relative orientation to determine the location of the user's head and to adjust audio playback based on the location of the user's head. After the processor 122 designates or establishes the relative orientation, the headphones 101 may then transmit audio cue to the user to indicate that the recentering method 200 is complete.

While in state 306, if the processor 112 determines that the user's head is still moving while the second timer has expired, then the processor 112 transmits an audio cue to notify the user that his/her head is still moving and that his/her head needs to come to a complete stop prior to storing or designating the relative orientation.

FIG. 4 depicts an example of an apparatus 400 exhibiting a relative orientation. The apparatus is generally shown as a kettle being positioned in three axes (e.g., x, y, z). FIG. 4 also illustrates that the kettle may be generally rotated at 15 degrees around the axes at (1,0,1). In this regard, the kettle may have a relative orientation of (1, 0, 1) that is rotated at 15 degrees. As shown, the relative orientation of the kettle is not perfectly centered on the three axis and has a slight angular rotation. If the kettle was replaced by the headphones in FIG. 4, the headphones 101 may also generally be rotated at 15 degrees around the axes at (1, 0, 1). However, for purposes of this disclosure, the kettle (or the headphones 101 as positioned on the user's head), may have its relative orientation established after undergoing any one of the methods 200 and 300.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A headphone assembly comprising:
headphones;
a switch configured to transmit a first signal indicative of a command to establish a relative orientation for the headphones;
at least one motion detector configured to transmit a second signal indicative of movement of the headphones relative to a user's head; and
at least one processor programmed to:
receive a first signal from the switch to establish the relative orientation of the headphones;
receive the second signal that indicates that the headphones are moving relative to the user's head;
determine that the headphones are in a stable state after moving relative to the user's head; and
establish the relative orientation of the headphones while positioned on the user's head in response to at least determining that the headphones are in the stable state.

2. The headphone assembly of claim 1, wherein the at least one processor is further programmed trigger a delay to enable a user to reach a natural head orientation after receiving the first signal from the switch.

3. The headphone assembly of claim 2, wherein the at least one processor is further programmed to execute a first timer to determine whether the headphones are in the stable state prior to the first timer expiring.

4. The headphone assembly of claim 3, wherein the headphones are programmed to transmit an alert to the user to remain still in response to the first timer expiring and the headphones being detected to be moving.

5. The headphone assembly of claim 4, wherein the alert corresponds to an audio cue to notify the user to remain still.

6. The headphone assembly of claim 3, wherein the at least one processor is further programmed to establish the relative orientation of the headphones while positioned on the user's head in response to the first timer expiring and the headphones being in the stable state.

7. The headphone assembly of claim 1, wherein the at least one processor is further programed to transmit an alert to the user to notify the user that the relative orientation of the headphones has been established in response to at least determining that the headphones are in the stable state.

8. The headphone assembly of claim 1, wherein the at least one motion detector is positioned on the headphones.

9. The headphone assembly of claim 1, wherein the switch is positioned on the headphones.

10. A computer program product embodied in a non-transitory computer readable medium that is programmed for determining relative orientation of headphones, the computer-program product comprising instructions and being executable by at least one processor for:
receiving a first signal indicative of a command to establish a relative orientation for the headphones from a switch to establish the relative orientation of the headphones;
receiving a second signal indicative of movement of the headphones relative to a user's head;
determining that the headphones are in a stable state after moving relative to the user's head; and
establishing the relative orientation of the headphones while positioned on the user's head in response to at least determining that the headphones are in the stable state.

11. The computer program product of claim 10 further comprising triggering a delay to enable the user to reach a natural head orientation after receiving the first signal.

12. The computer program product of claim 11 further comprising executing a first timer to determine whether the headphones are in the stable state prior to the first timer expiring.

13. The computer program product of claim 12 further comprising transmitting an alert to the user to remain still in response to the first timer expiring and the headphones being detected to be moving.

14. The computer program product of claim 13, wherein the alert corresponds to an audio cue to notify the user to remain still.

15. The computer program product of claim 13 further comprising establishing the relative orientation of the headphones while positioned on the user's head in response to the first timer expiring and the headphones being in the stable state.

16. The computer program product of claim 10 further comprising transmitting an alert to the user to notify the user that the relative orientation of the headphones has been established in response to at least determining that the headphones are in the stable state.

17. A headphone assembly comprising:
headphones;
at least one motion detector configured to transmit a first signal indicative of movement of the headphones; and
at least one processor programmed to:
determine that the headphones are on a user's head; and
establish a relative orientation of the headphones while positioned on the user's head as a frame of reference for subsequent relative orientation measurements in response to at least determining that the headphones are in a stable state while being worn by the user and after the determining that the headphones are on the user's head.

18. The headphone assembly of claim 17, wherein the at least one processor is further programmed to determine that the headphones had moved from a surface positioned off of the user's head prior to establishing the relative orientation of the head.

19. The headphone assembly of claim 17, wherein the at least one processor is further programmed to transmit an alert to the user to remain still in response to determining that the headphones are not in the stable state while being worn by the user.

20. The headphone assembly of claim 17, wherein the at least one motion detector is positioned on the headphones.
